(19) United States
(12) Patent Application Publication
(10) Pub. No.: US 2013/0151021 A1
(43) Pub. Date: Jun. 13, 2013

(54) APPARATUS AND METHOD FOR DETERMINING POWER USING MODE

(71) Applicant: Ki Seok Kim, Daegu (KR)

(72) Inventor: Ki Seok Kim, Daegu (KR)

(73) Assignee: Electronics and Telecommunications Research Institute, Daejeon (KR)

(21) Appl. No.: 13/476,509

(22) Filed: May 21, 2012

(30) Foreign Application Priority Data
Dec. 7, 2011 (KR) 10-2011-0130587

(51) Int. Cl. G06F 1/26

(52) U.S. Cl. 700/286

(57) ABSTRACT

Disclosed are an apparatus and a method for determining a power using mode of an electric device when there is a demand response request. The apparatus for determining a power using mode, includes: a message receiver receiving a demand response request message requesting a reduction in use of power of a smart grid management server; an information receiver receiving status information of the energy storage means; a determinator determining whether power supply from the energy storage means is performed using the status information of the energy storage means when receiving the demand response request message, and determining a power using mode of the electric device according to the determining whether the power supply is performed.

### CROSS-REFERENCE TO RELATED APPLICATIONS

This application claims priority to and the benefit of Korean Patent Application No. 10-2011-0130587 filed in the Korean Intellectual Property Office on Dec. 7, 2011, the entire contents of which are incorporated herein by reference.

### TECHNICAL FIELD

The present invention relates to an apparatus and a method for determining a power using mode of an electric device when there is a demand response (DR) request.

More particularly, the present invention relates to an apparatus and a method for determining possibility of power supply by an energy storage means when there is the demand response request to determine the power using mode of the electric device.

### BACKGROUND ART

A smart grid is a next generation intelligent power network in which a power provider and a consumer bilaterally exchange real-time information using a combination of an existing power network and information technology (IT) to optimize energy efficiency.

A demand response request in the smart grid refers to receiving a demand response request message when power consumption exceeds a predetermined ratio of power supplied from a power plant, and requesting a reduction in used power consumption to a smart meter for determining a power using mode of an electric device. A smart grid management server for managing the smart grid transmits the demand response request message. The smart meter receives the demand response request message and operates an electric device in a power saving mode according to an automatic set state. The smart meter recommends an electric device user to recognize presence of reception of the demand response request message and use the electric device in a power saving mode. Operation of the electric device in the power saving mode means that respective electric devices operate in a mode such as a power saving mode or a termination mode, which operates in a mode using less power in comparison with power usage of a general case.

The electric device refers to devices that operate using electricity such as a computer, a refrigerator, an air conditioner, or a fluorescent lamp which a power consumer utilizes in an office or a house.

After transferring the demand response request message, when power consumption is less than or equal to a predetermined ratio of power supplied from the power plant, the smart grid management server transfers a demand response request release message to the smart meter. The smart meter receiving the demand response request release message automatically sets a general using mode as a power using mode of the electric device. The smart meter causes the user to recognize presence of reception of a demand response request release message so that the electric device may be operated in the general using mode.

Because a power network using the smart grid is easy for a power provider to control peak power, the power network has an advantage in that a cost for controlling peak power is reduced. However, when the smart grid management server requests a demand response to consumers, it is inconvenient for the consumers to use the electric device in a mode using less power such as a power saving mode. For example, an air conditioner operates due to warm weather and the air conditioner is changed to the saving mode, with the result that the air conditioner may not be operated or be operated to output weak cooling air. To operate a heater for using hot water, the heater is changed to a saving mode with the result that the hot water cannot be used.

### SUMMARY OF THE INVENTION

The present invention has been made in an effort to provide an apparatus and a method for determining a using mode which may actively respond to a demand response request using energy stored in an energy storage means capable of storing the energy such as an electric vehicle so as to solve a user of such an electronic device.

An exemplary embodiment of the present invention provides an apparatus for determining a power using mode, including: a message receiver receiving a demand response request message requesting a reduction in use of power of a smart grid management server; an information receiver receiving status information of the energy storage means; and a determinator determining whether power supply from the energy storage means is performed using the status information of the energy storage means when receiving the demand response request message, and determining a power using mode of the electric device according to the determination whether the power supply is performed.

When the determinator determines that power supply from the energy storage means is performed, the determinator may determine a general using mode as a power using mode of the electric device.

When the determinator determines that the power supply from the energy storage means is not performed, the determinator may determine a mode using less power as the power using mode of the electric device.

The information received by the information receiver may be information regarding a remaining energy amount stored in the energy storage means.

The information regarding the remaining energy amount may be information considering at least one of a usage plan and a chargeable time of the energy storage means.

The energy storage means may be at least one of an electric vehicle, a hybrid electric vehicle, or a charger.

The demand response request message received by the message receiver may include charge information by time periods.

Another exemplary embodiment provides a method for determining a power using mode, including: receiving a demand response request message requesting a reduction in use of power from a smart grid management server by a message receiver; receiving status information of an energy storage means from the energy storage means by an information receiver; and when the demand response request message is received, determining whether power supply from the energy storage means is performed using the status information of the energy storage means, and determining a power using mode of the electric device according to the determination whether the power supply is performed by a determinator.

When it is determined that power supply from the energy storage means is performed, the determining may include determining a general using mode as a power using mode of the electric device.

When it is determined that the power supply from the energy storage means is not performed, the determining may include determining a mode using less power as the power using mode of the electric device.

The information received by the information receiver may be information regarding a remaining energy amount stored in the energy storage means.

The information regarding the remaining energy amount may be information considering at least one of a usage plan and a chargeable time of the energy storage means.

The energy storage means may be at least one of an electric vehicle, a hybrid electric vehicle, or a charger.

In the receiving of the message, the demand response request message may include charge information by time periods.

According to exemplary embodiments of the present invention, it is possible to flexibly determine a power using mode of an electric device by operative cooperation with possibility of determining power supply in an energy storage means instead of uniformly using the power using mode according to a demand response request, thereby solving inconvenience on the use of the electric device for a consumer

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an apparatus for determining a power using mode according to an exemplary embodiment of the present invention.

FIG. 2 is a diagram illustrating a system to which the apparatus for determining a power using mode according to the exemplary embodiment of the present invention is applied.

FIG. 3 is a flowchart illustrating an operation of the system to which the apparatus for determining a power using mode according to the exemplary embodiment of the present invention is applied.

FIG. 4 is a flowchart illustrating a method for determining a power using mode according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings, and thus the duplicated description for the same components will be omitted. In describing the present invention, well-known functions or constructions will not be described in detail since they may unnecessarily obscure the understanding of the present invention.

In addition, when a component is referred to as being “connected to” or “linked to” another component, the component may be directly connected to or linked to another component or an intervening component may be present therebetween. In contrast, when a component is referred to as being “directly connected to” or “directly linked to” another component, an intervening component may not be present therebetween.

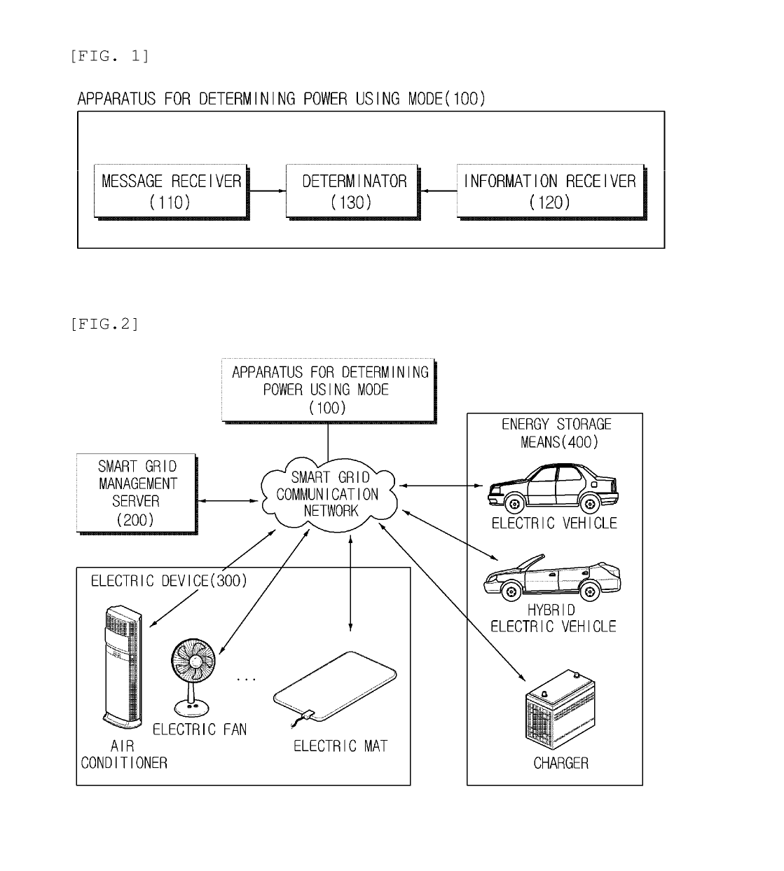

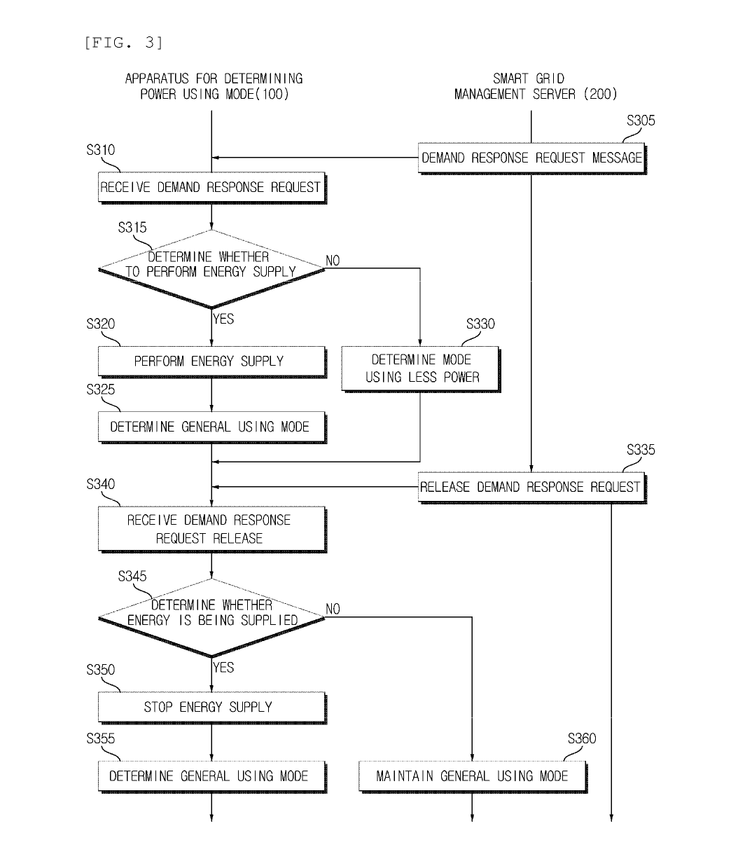

FIG. 1 is a block diagram illustrating an apparatus for determining a power using mode according to the exemplary embodiment of the present invention. FIG. 2 is a diagram illustrating a system to which the apparatus for determining a power using mode according to the exemplary embodiment of the present invention is applied. The apparatus 100 for determining a power using mode according to the exemplary embodiment of the present invention will be described with reference to FIGS. 1 and 2.

The apparatus 100 for determining a power using mode according to the exemplary embodiment of the present invention includes a message receiver 110, an information receiver 120, and a determinator 130.

The message receiver 110 receives a demand response request message requesting a reduction in use of power. The demand response request message is a message which is transmitted from a smart grid management server 200 to the message receiver 110 when power consumption exceeds a predetermined ratio of power supplied from a power plant.

Specifically, the demand response request message received by the message receiver 110 may include charge information by time periods. The demand response request message may function to control the use of power by time periods together with the charge information by time periods. The demand response request message may function to reduce the use of power in a time period with a high power demand in which an electric charge is relatively high by controlling use of power by time periods. As described above, when power consumption exceeds a predetermined ratio of a power supply amount, the demand response request message requests reduction in the use of the power. A higher electric charge than an average electric charge may be determined as an electric charge when sending the demand response request message. Accordingly, the smart grid management server may include charge information by time periods in the demand response request message to reduce used power consumption.

The information receiver 120 receives status information of the energy storage means 400. The energy storage means 400 includes an electric vehicle (EV), a hybrid electric vehicle, a charger, a battery, and the like.

Energy storage means provided in a private person, a house, or an office may all be included in the energy storage means 400. The smart grid management server 200 may function to generally manage an intelligent computer network. When there is a need for the demand response request, the demand response request message is transmitted to a message receiver 120 of each house or office.

The status information of the energy storage means 400 may be information regarding a remaining energy amount stored in the energy storage means 400. The information regarding the remaining energy amount stored in the energy storage means 400 may be information considering at least one of a usage plan and a chargeable time set in the energy storage means 400. For example, when the energy storage means 400 is an electric vehicle, the information considering the usage plan refers to information which considers the remaining energy degree comparing an expected using time, an expected using moving distance of the electric vehicle which the user of the electric vehicle inputs in the electric vehicle, and office-going/closing hours which the user drives the electric vehicle on average and frequency with each other. Such considerations may further include chargeable energy for a computed chargeable time achieved by computing a chargeable time to the expected using time of the electric vehicle.

When receiving the demand response request message, the determinator 130 determines whether power supply from the energy storage means 400 is performed using the status information of the energy storage means 400, and determines a power using mode of the electric devices 300 according to the determining whether the power supply is performed.

Specifically, the determining whether the power from the energy storage means 400 is supplied using the status information of the energy storage means 400 may either mean to be able to operate the electric device 300 in a general using mode based on status information such as remaining energy of the energy storage means 400 or mean to determine whether energy capable of operating the electric device 300 in a mode such as a saving mode using less power is stored in the energy storage means 400 using the status information.

When the determinator 130 determines that power supply from the energy storage means 400 is performed, the determinator 130 determines to operate a power using mode of the electric device 300 in a general using mode generally using power without operating the electric device 300 in the power using mode using less power according to a request for the demand response request message. Such determination is because power may be received from the energy storage means 400 to operate the electric device in a general using mode although less power is supplied from a power plant.

A house, an office, or the like may be directly connected to the energy storage means 400 and receive the power from the energy storage means 400. The energy storage means 400 may be connected to a power network system of the smart grid, and the house, the office, or the like may receive power of the energy storage means from the power network of the smart grid.

When the determinator 130 determines that the power supply from the energy storage means 400 is not performed, the determinator 130 determines to operate the power using modes of the electric devices 300 in a mode using less power than general power consumption according to a request of the demand response request message. In general, the mode using less power than general power consumption may be referred to as a power saving mode, a termination mode, a standby mode, or the like.

The determinator 130 may supply a predetermined level of power in consideration of a remaining power level of the energy storage means 400 while the energy storage means 400 supplies the power, and may control the power using mode of the electric device 300 by selecting one of a general using mode or a mode using less power.

In more detail, reception of power from the energy storage means 400 is called a Vehicle to Grid (V2G) when the energy storage means 400 is a vehicle such as an electric vehicle or a hybrid electric vehicle. As a preferable example of the V2G, the power consumer may charge the electric vehicle and a hybrid electric vehicle with power during a night time period when an electric charge is low because of low power consumption, and receive power for operating the electric device 300 using energy charged in the electric vehicle, the hybrid vehicle, or the like during a day time period when an electric charge is high because of high power consumption.

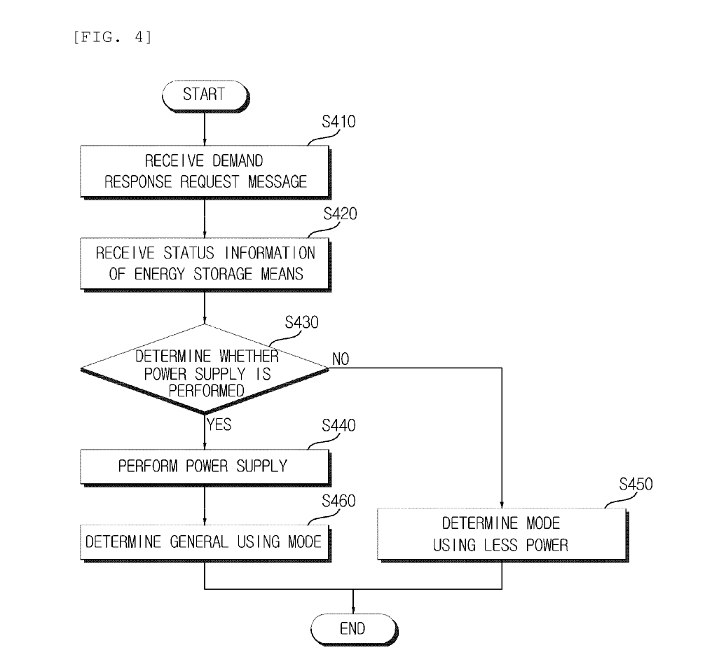

FIG. 2 is a diagram illustrating a system to which the apparatus for determining a power using mode according to the exemplary embodiment of the present invention is applied. FIG. 3 is a diagram illustrating an operation of the system to which the apparatus for determining a power using mode according to the exemplary embodiment of the present invention is applied. The following is a description of the system to which the apparatus 100 for determining a power using mode according to the exemplary embodiment of the present invention is applied with reference to FIGS. 2 and 3.

Referring to FIG. 2, a smart grid management server 200, an electric device 300, and an energy storage means 400 are connected to the apparatus 100 for determining a power using mode according to the exemplary embodiment of the present invention. The connection may be achieved by a smart grid communication network.

A message receiver 110 of the apparatus 100 for determining a power using mode receives a demand response request message from the smart grid management server 200. An information receiver 120 of the apparatus 100 for determining a power using mode is connected to the energy storage means 400 via a wired or wireless scheme and receives information from the energy storage means 400. The information received by the information receiver 120 from the energy storage means 400 indicates whether power from the energy storage means 400 may be supplied to the electric device 300. The determinator 130 of the apparatus 100 for determining a power using mode may be connected to the electric devices 300 in a wired or wireless scheme. When the determinator 130 determines the power using mode, the electric devices 300 are operated in the predetermined power using mode.

An intelligent computer network monitors power information in real time, and controls flow of power to maximize energy efficiency. Accordingly, there is a need for a smart grid communication network to monitor the power information in real time and control the flow of the power. The energy storage means 400, the electric device 300, the apparatus 100 for determining a power using mode, and the smart grid management server 200 are generally connected to each other through a wired or wireless smart grid communication network. The smart grid communication network may be a remote measuring communication network, an IEEE 802 LAN/MAN, or the like using a power line communication (PLC) technology. Various information may be transmitted through the smart grid communication network.

Referring to FIG. 3, when a smart grid management server 200 transmits a demand response request message to an apparatus 100 for determining a power using mode (step S305), the apparatus 100 for determining a power using mode receives the demand response request message (step S310), and determines whether to perform energy supply from the energy storage means 400 based on status information of the energy storage means 400 (step S315). When the apparatus 100 for determining a power using mode determines to perform the energy supply from the energy storage means 400, the apparatus 100 for determining a power using mode performs the energy supply (step S320), and determines a general using mode as the power using mode of the electric device 300 (step S325). When the apparatus 100 for determining a power using mode determines that the energy supply from the energy storage means 400 is not performed, the apparatus 100 for determining a power using mode determines the power using mode of the electric device 300 as a mode using less power (step S330).

When power consumption is less than or equal to a predetermined ratio of a power supply amount, the smart grid management server 200 transmits a demand response request release message (step S335). The energy storage means 400 receives the demand response request release message (step S340). The apparatus 100 for determining a power using mode determines whether the energy from the energy storage means 400 is being supplied (step S345). When the energy is being supplied, the energy storage means 400 stops the supply of the energy (step S350). The apparatus 100 for determining a power using mode determines the general using mode as the power using mode of the electric device (step S355). When the smart grid management server 200 transmits the demand response request release message, if the supply of the energy is not performed, the energy storage means 400 continuously uses the general using mode (step S360). An used electric charge in a case where power is continuously consumed in the general using mode may be higher in comparison with a case where the energy storage means 400 executes the energy supply to be used in a mode using less power and the power using mode is changed to the general using mode upon releasing the demand response request. The reason why is an electric charge during a time period when there is the demand response request is generally determined to be higher in comparison with an electric charge during a night time period when energy is charged in the energy storage means 400.

Through the apparatus 100 for determining a power using mode of the prevent invention as described above, unlike a passive response using the electric device 300 in which a power using mode of the electric device 300 is changed to a mode using less power according to the demand response request message of the smart grid management server 200, when receiving the demand response request message, it is determined whether the energy stored in the energy storage means 400 may be used so that the electric device 300 may actively respond to the demand response request to solve inconvenience on the use of the electric device 300 by a power consumer. That is, when the energy stored in the energy storage means 400 may be used, the electric devices 300 may be operated in a general using mode using general power other than a mode using less power in spite of the demand response request to solve inconvenience of a user of an electric device 300.

A power consumer stores energy in the energy storage means 400 using a night time period when an electric charge is low due to reduced power consumption. When there is a demand response request in which an electric charge is higher than that in the night time period, the power receiving from a power plant using the energy stored in the energy storage means 400 may be reduced to reduce the used electric charge.

Since the power plant may reduce a power supply amount in proportion to use of the energy stored in the energy storage means 400, the power plant has advantages in that peak power and a load of the power plant are reduced, and deterioration of power quality is prevented.

FIG. 4 is a flowchart illustrating a method for determining a power using mode according to the exemplary embodiment of the present invention.

Step S410 is a step of receiving a demand response request message requesting reduction in use of power. A smart grid management server 200 transmits the demand response request message and a message receiver 110 of an apparatus 100 for determining a power using mode receives the transmitted demand response request message. The demand response request message may include electric charge information by time periods.

Step S420 is a step of receiving status information of the energy storage means 400 from the energy storage means 400.

The status information of the energy storage means 400 may be information about remaining energy amount stored in the energy storage means 400. The information about the remaining energy amount stored in the energy storage means 400 may be information in consideration of a usage plan and a chargeable time set in the energy storage means 400.

Step S430 is a step of determining whether power supply from the energy storage means 400 is performed. The determinator 130 determines whether the power supply from the energy storage means 400 is performed. When receiving the demand response request message by a message receiver 110, the determinator 130 determines whether the power supply from the energy storage means 400 is performed.

Specifically, the determinator 130 determines whether power supply is performed based on the status information of the energy storage means 400 received by the information receiver 120. The determination whether the supply power from the energy storage means is performed using the status information of the energy storage means 400 is achieved considering whether energy capable of operating the electric device 300 in the general using mode is stored in the energy storage means 400 or how much is an available time when the remaining energy of the energy storage means 400 operates the electric device 300 in the general using mode even if the energy storage means 400 receives the power from the power plant corresponding to power used when the electric device 300 may be operated in a general using mode or the electric devices 300 are operated in a mode using less power such as a power saving mode based on status information of the energy storage means 400 such as remaining energy.

In step S440, when the apparatus 100 for determining a power using mode determines performing the energy supply from the energy storage means 400, the apparatus 100 for determining a power using mode performs the energy supply to the electric device 300 from the energy storage means 400.

When the power is supplied, the apparatus 100 for determining a power using mode may determine that the electric devices 300 are operated in the general using mode independent of a demand response request message (step S460).

Step S450 is a step of determining a mode using less power as the electric using mode of the electric device 300 by the apparatus 100 for determining a power using mode when the apparatus 100 for determining a power using mode determines not to perform the energy supply from the energy storage means 400. When the determinator 130 determines that the performing power supply from the energy storage means 400 to the electric device 300 is impossible, the determinator 130 determines a mode using less power as the using mode of the electric device 300.

In the method for determining a power using mode of the present invention, according to a demand response request of a smart grid management server 200, an electric device user may not always use the electric device in a mode using less power, and actively respond to a demand response request using energy stored in the energy storage means 400 such as an electric vehicle, a hybrid electric vehicle, and a battery. That is, when the energy stored in the energy storage means 400 may be used even if there is a demand response request, the electric device 300 may be operated in the general using mode other than the mode using less power. Owing to this, a power consumer may solve inconvenience on use of the electric device 300 according to the demand response request.

The power consumer stores energy in the energy storage means 400 using a night time period when an electric charge is low because of small power consumption. When there is a demand response request in which an electric charge is higher in comparison than during a night time period, power receiving from a power plant using energy stored in the energy storage means 400 may be reduced, thereby reducing a used electric charge.

The smart grid management server 200 may reduce a cost required to always maintain a power supply amount larger than power consumption.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for determining a power using mode, comprising:
a message receiver receiving a demand response request message requesting a reduction in use of power from a smart grid management server;
an information receiver receiving status information of an energy storage means; and
a determinator determining whether power supply from the energy storage means is performed using the status information of the energy storage means when receiving the demand response request message, and determining a power using mode of the electric devices according to the determining whether the power supply is performed.

2. The apparatus of claim 1, wherein when the determinator determines that power supply from the energy storage means is performed, the determinator determines a general using mode as a power using mode of the electric device.

3. The apparatus of claim 1, wherein when the determinator determines that the power supply from the energy storage means is not performed, the determinator determines a mode using less power as the power using mode of the electric device.

4. The apparatus of claim 1, wherein the information received by the information receiver is information regarding a remaining energy amount stored in the energy storage means.

5. The apparatus of claim 4, wherein the information regarding the remaining energy amount is information considering at least one of a usage plan and a chargeable time of the energy storage means.

6. The apparatus of claim 1, wherein the energy storage means is at least one of an electric vehicle, a hybrid electric vehicle, or a charger.

7. The apparatus of claim 1, wherein the demand response request message received by the message receiver includes charge information by time periods.

8. A method for determining a power using mode, comprising:
receiving a demand response request message requesting a reduction in use of power of a smart grid management server by a message receiver;
receiving status information of an energy storage means from the energy storage means by an information receiver; and
when the demand response request message is received, determining whether power supply from the energy storage means is performed using the status information of the energy storage means, and determining a power using mode of the electric device according to the determining whether the power supply is performed.

9. The method of claim 8, wherein when it is determined that power supply from the energy storage means is performed, the determining includes determining a general using mode as a power using mode of the electric device.

10. The method of claim 8, wherein when it is determined that the power supply from the energy storage means is not performed, the determining includes determining a mode using less power as the power using mode of the electric device.

11. The method of claim 8, wherein the information received by the information receiver is information regarding a remaining energy amount stored in the energy storage means.

12. The method of claim 11, wherein the information regarding the remaining energy amount is information considering at least one of a usage plan and a chargeable time of the energy storage means.

13. The method of claim 8, wherein the energy storage means is at least one of an electric vehicle, a hybrid electric vehicle, or a charger.

14. The method of claim 8, wherein in the receiving of the message, the demand response request message includes charge information by time periods.
